(19) United States
(12) Patent Application Publication
(10) Pub. No.: US 2014/0258847 A1
(43) Pub. Date: Sep. 11, 2014

(54) SYSTEMS AND METHODS FOR DISPLAYING CONTENT WITH DISCRETE CONTENT ZONES

(71) Applicant: SAY MEDIA, INC., San Francisco, CA (US)

(72) Inventor: Adrian Cleave, San Francisco, CA (US)

(73) Assignee: Say Media, Inc., San Francisco, CA (US)

(21) Appl. No.: 13/793,714

(22) Filed: Mar. 11, 2013

(51) Int. Cl. G06F 17/22

(52) U.S. Cl. CPC G06F 17/2247
USPC 715/235; 715/234

(57) ABSTRACT

Systems and methods for content display devices configured to display content with discrete content zones are disclosed. In one embodiment, a content display device includes memory configured to store a content display application, a network interface, a display, an input device, and a processor, wherein the content display application configures the processor to receive web page data using the network interface including a plurality of pieces of content data and at least one script, generate an object model using the at least one piece of content data, render the received web page data using the object model containing a plurality of discrete content zones, display the rendered web page data, receive input, modify the generated object model using the received input and the at least one script, re-render the web page data using the modified object model, and display the re-rendered web page data.

### FIELD OF THE INVENTION

The present invention relates to systems and methods for displaying content using content display devices and more specifically to displaying content with discrete content zones.

### BACKGROUND

The Internet is a global system of interconnected computer networks. A variety of services are provided on the Internet, including websites. Websites include a variety of content, such as text, pictures, audio data, video data, and other interactive content. Web sites are typically hosted using web servers and a web browser is an application that enables a user to receive, view, and interact with a websites hosted on web servers. A variety of web browsers are commonly used to view websites, including Internet Explorer from Microsoft Corporation of Redmond, Wash. and the Chrome browser from Google, Inc. of Mountain View, Calif.

Many documents, including web pages within a website, are often written using the Hypertext Markup Language (HTML). A HTML document contains a set of nested tags. HTML tags include data stored in the tag, either as a property of the tag or between an opening tag and a closing tag. Web browsers do not display the HTML tags; rather, web browsers are configured to parse a HTML document and render a website including the information stored in the HTML tags.

Cascading Style Sheets (CSS) are used to describe the formatting and display of a document when it is rendered, although a CSS may be used to describe the formatting of a variety of documents, including HTML documents and other documents, such as documents written using the Extensible Markup Language (XML). A single document may have a variety of associated CSS, so that the document can be rendered in a variety of ways depending on the properties of the device used to display the document. For example, a HTML document can be rendered with one format in a web browser on a desktop computer using a CSS designed for a desktop browser, while the same HTML document can be rendered in a second format in a web browser running on a mobile phone using a second CSS designed for a mobile browser.

The Document Object Model (DOM) is a standard defined by the Word Wide Web Consortium that defines the creation of an in-memory object model corresponding to data contained in documents, including HTML and XML documents. These objects are stored in a DOM tree and are utilized by web browsers to render and manipulate documents. When a HTML document is rendered in a web browser, the browser parses the HTML into an in-memory DOM that is used to display the HTML document. Web browsers contain one or more layout engines configured to create a DOM from a document. Many layout engines are used today, including the open-source WebKit layout engine utilized by the Chrome browser and the Apple Safari browser from Apple, Inc. of Cupertino, Calif. and the Trident layout engine used in Internet Explorer.

Many web pages utilize scripts in order to provide flexibility in the creation and display of a web page. Scripts may be written in a variety of languages, including ECMAScript, standardized and ECMA-262 by ECMA International of Geneva, Switzerland and related scripting languages including JavaScript by the Mozilla Foundation of Mountain View, Calif. Web browsers are configured to parse and execute scripts contained in web pages. These scripts can control the appearance of a web page, customize the content according to the preferences of a user viewing the web page, and allow for data to be received using the web page. Scripts may be server-side, where the script is run on a web server, or client-side, where the script is run using the web browser receiving the script.

### SUMMARY OF THE INVENTION

Systems and methods for content display devices configured to display content with discrete content zones in accordance with embodiments of the invention are disclosed. In one embodiment, a content display device includes memory configured to store a content display application, a network interface configured to receive web page data, a display configured to display content data, an input device configured to receive input data, and a processor, wherein the content display application configures the processor to receive web page data using the network interface, where the web page data includes a plurality of pieces of content data and at least one script, generate an object model using the at least one piece of content data, render the received web page data using the object model, where the rendered web page data contains a plurality of discrete content zones and at least one piece of content data is associated with each discrete content zone, display the rendered web page data using the display, receive input using the input device, modify the generated object model using the received input and the at least one script, where the at least one script is configured to independently map the received input to one or more of the discrete content zones, re-render the web page data using the modified object model, and display the re-rendered web page data using the display.

In an additional embodiment of the invention, the web page data includes a link to remote content data and the content display application further configures the processor to receive remote content data using the link to remote content data.

In another embodiment of the invention, the web page data includes at least one cascading style sheet and the content display application further configures the processor to render the received web page data using the at least one cascading style sheet.

In yet another additional embodiment of the invention, the content display application further configures the processor to select a cascading style sheet from the at least one cascading style sheet based upon the display and the input device, where the selected cascading style sheet is used to render the received web page data.

In still another additional embodiment of the invention, the received input includes scrolling data and rendering the received web page data includes determining the portion of the web page data is visible in at least one discrete content zone using the scrolling data.

In yet still another additional embodiment of the invention, at least one piece of content data further includes a smart footer and the content display application further configures the processor to request additional content when the smart footer is rendered, associate the requested additional content with the discrete content zone associated with the piece of content data having the smart footer, and update the object model using the requested additional content.

In yet another embodiment of the invention, the at least one discrete content zones includes a discrete content zone height and the content display application further configures the processor to update the discrete content zone height when additional content is associated with the discrete content zone.

In still another embodiment of the invention, the received web page further includes a web page header, each discrete content zone in the plurality of discrete content zones further includes a discrete content zone top, and the content display application further configures the processor to render the web page such that the web page header appears at the beginning of the rendered web page and independently map input to the plurality of discrete content zones so that the top of each discrete content zone is aligned with the web page header.

In yet still another embodiment of the invention, the received web page further includes a web page footer, each discrete content zone in the plurality of discrete content zones further includes a discrete content zone bottom, and the content display application further configures the processor to render the web page such that the web page footer appears at the end of the rendered web page and independently map input to the plurality of discrete content zones so that the bottom of each discrete content zone is aligned with the web page footer.

In yet another additional embodiment of the invention, the content display application further configures the processor to determine when a first discrete content zone has displayed all of the pieces of content data associated with the first discrete content zone have been displayed, determine that a second discrete content zone has additional pieces of content data associated with the second discrete content zone that have not been displayed, fix the position of the second discrete content zone relative to the first discrete content zone, and continue mapping input data to the second discrete content zone to cause the display of additional pieces of content data associated with the second discrete content zone that have not been displayed.

Still another embodiment of the invention includes a method for displaying content with discrete content zones including receiving web page data using a content display device, where the web page data includes a plurality of pieces of content data and at least one script, generating an object model using the at least one piece of content data and the content display device, rendering the received web page data using the object model and the content display device, where the rendered web page data contains a plurality of discrete content zones and at least one piece of content data is associated with each discrete content zone, displaying the rendered web page data using the content display device, receiving input using the content display device, modifying the generated object model using the received input, the at least one script, and the content display device, where the at least one script is configured to independently map the received input to one or more of the discrete content zones, re-rendering the web page data using the modified object model and the content display device, and displaying the re-rendered web page data using the content display device.

In yet another additional embodiment of the invention, displaying content with discrete content zones further includes receiving remote content data using the content display device, where the web page data includes a link to the remote content data.

In still another additional embodiment of the invention, displaying content with discrete content zones further includes rendering the received web page data using the content display device and at least one cascading style sheet included in the web page data.

In yet still another additional embodiment of the invention, displaying content with discrete content zones further includes selecting a cascading style sheet from the at least one cascading style sheet based upon the content display device using the content display device, where the selected cascading style sheet is used to render the received web page data.

In yet another embodiment of the invention, displaying content with discrete content zones further includes determining the portion of the web page data is visible in at least one discrete content zone in the rendered web page data using the content display device.

In still another embodiment of the invention, displaying content with discrete content zones further includes requesting additional content when a smart footer contained in a piece of content data is rendered using the content display device, associating the requested additional content with the discrete content zone associated with the piece of content data having the smart footer using the content display device, and updating the object model using the requested additional content and the content display device.

In yet still another embodiment of the invention, displaying content with discrete content zones further includes updating a discrete content zone height associated with the discrete content zone when additional content is associated with the discrete content zone using the content display device.

In yet another additional embodiment of the invention, displaying content with discrete content zones further includes rendering the web page using the content display device such that a web page header included in the web page data appears at the beginning of the rendered web page and independently mapping input to the plurality of discrete content zones using the content display device so that the top of each discrete content zone is aligned with the web page header.

In still another additional embodiment of the invention, displaying content with discrete content zones further includes rendering the web page using the content display device such that the web page footer appears at the end of the rendered web page and independently mapping input to the plurality of discrete content zones using the content display device so that the bottom of each discrete content zone is aligned with the web page footer.

In yet still another additional embodiment of the invention, displaying content with discrete content zones further includes determining when a first discrete content zone has displayed all of the pieces of content data associated with the first discrete content zone have been displayed using the content display device, determining that a second discrete content zone has additional pieces of content data associated with the second discrete content zone that have not been displayed using the content display device, fixing the position of the second discrete content zone relative to the first discrete content zone using the content display device, and continuing mapping input data to the second discrete content zone to cause the display of additional pieces of content data associated with the second discrete content zone that have not been displayed using the content display device.

### BRIEF DESCRIPTION OF THE DRAWINGS

FIG. 1 conceptually illustrates a content display system in accordance with an embodiment of the invention.

FIG. 2 is a conceptual illustration of a content display device configured to displaying content in discrete content zones in accordance with an embodiment of the invention.

FIG. 3 is a flow chart illustrating a process for receiving and displaying content with discrete content zones in accordance with an embodiment of the invention.

FIG. 4 is a flow chart illustrating a process for interacting with content with discrete content zones in accordance with an embodiment of the invention.

FIG. 5 is a conceptual illustration of content with discrete content zones in accordance with an embodiment of the invention.

FIG. 6 is a conceptual illustration of content with discrete content zones including a smart feed in accordance with an embodiment of the invention.

### DETAILED DESCRIPTION

Turning now to the drawings, systems and methods for displaying content with discrete content zones in accordance with embodiments of the invention are illustrated. When displaying content, such as web pages, web browsers receive input, such as scrolling vertically and/or horizontally, to control which portion of the content is displayed. This input is mapped to actions or events that are generated by a web browser or the operating system of a content display device. For example, in many embodiments of the invention, an input representative of a horizontal input causes a horizontal input event to be generated by the operating system of the content display device; the web browser receives the horizontal input event and executes a corresponding method to horizontally move the content rendered in the web browser. Traditional web browsers are configured to display a single content zone. This zone of content may contain elements that move within the content zone in response to the generated events; however, the elements are not independent sources of content.

Content display devices in accordance with embodiments of the invention are configured to display content, such as web pages, having a plurality of discrete content zones, each content zone having its own height and source of content. Additionally, each content zone is configured to have its own response to input received using the content display device. In accordance with embodiments of the invention, content display devices include computers running web browsers configured to display hypertext markup language (HTML) web pages using cascading style sheets (CSS) and one or more scripts written in one or more scripting languages, such as ECMAScript, JavaScript, PHP, Perl, or another scripting language, representing the web page using the document object model (DOM). In a number of embodiments, the CSSs are used to define the HTML defining the web page and the CSSs are utilized to define and style the discrete content zones. In several embodiments, the web page contains a script configured to map the input received using the web browser to each discrete content zone in the web page. In many embodiments, the web page contains a script configured to dynamically resize at least one discrete content zone depending on the content contained in at least one other discrete content zone. In a variety of embodiments, the scripts are configured to display a portion of content in a fixed position in a discrete content zone. In many embodiments, displaying a fixed portion of content has the effect of interrupting the flow of content in the web page. In a number of embodiments, the scripts are configured to modify the content of the web page/and or directly modify the DOM model representing the web page in the web browser. These scripts may be contained in one or more files included in the web page and/or included inline in the web page.

Although content display devices are described above with respect to HTML, CSS, and JavaScript, any variety of techniques, including HTML frames and web pages that do not utilize CSS, may be utilized in accordance with embodiments of the invention. Systems and methods for displaying content with discrete content zones in accordance with embodiments of the invention are described below.

### Content Display Systems

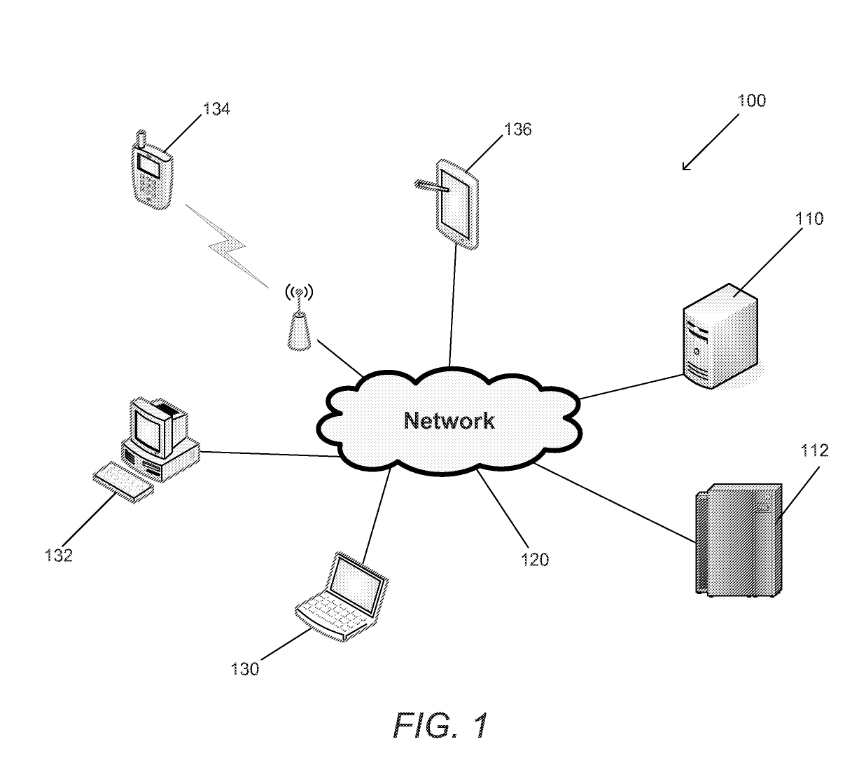

Content display systems in accordance with embodiments of the invention enable content display devices to receive content with discrete content zones and display the received content. A content display system in accordance with an embodiment of the invention is illustrated in FIG. 1. The content display system 100 includes a web server 110 connected to one or more content display devices via a network 120. The content display system 100 also contains a content source 112 configured to provide content to the web server 110 and/or the content display devices. The content devices include, but are not limited to, laptop computers 130, personal computers 132, cellular telephones 134, and tablet devices 136.

In accordance with embodiments of the invention, the web server 110 is configured to receive additional content from the content source 112 for inclusion in content having discrete content zones that will be sent to one or more content display devices. In a number of embodiments, the content display devices are configured to request and/or receive additional content from the content source 112. In several embodiments, the web server 110 and/or the content source 112 is implemented using a single server. In a number of embodiments, the web server 110 and/or the content source 112 is implemented using a plurality of servers. In many embodiments, the network 120 is the Internet.

The content display devices are configured to receive a content having discrete content zones from the web server 110 and to request and/or receive additional content from the content source 112 using the received content having discrete content zones. In a variety of embodiments, the content contains at least one script describing the manner in which the interactions with at least one discrete content zone impacts at least one other discrete content zone. Interactions include, but are not limited to, scrolling events and mouse clicks in accordance with the requirements of particular embodiments of the invention. In many embodiments, at least one script in the content describes the content contained in at least one discrete content zone. In accordance with embodiments of the invention, one or more of the discrete content zones in the received content may be populated with content received from the web server 110 and/or additional content received from the content source 112. In many embodiments, the content display devices are configured to dynamically resize the discrete content zones depending on the received content that is used to populate the individual discrete content zones. In accordance with embodiments of the invention, the content having discrete content zones is a web page including HTML, CSS, and scripts and the content display devices are configured to render the received web page. In many embodiments, a content display device creates an in-memory object model as part of the rendering of the received web page. In these embodiments, the content display devices are configured to display the discrete content zones by modifying the in-memory object model and/or the actual received web page. Content display devices in accordance with embodiments of the invention are configured to receive input for navigating the rendered web page and to dynamically render the discrete content zones contained in the web page using the received input. Furthermore, the content display devices are configured to independently map the received input to one or more of the discrete content zones. In a variety of embodiments, the content display devices are configured to interrupt the mapping of the received input to one or more of the discrete content zones.

Although a specific content display system is conceptually illustrated in FIG. 1, alternative architectures, including those with content display devices in peer-to-peer communication, can also be utilized in accordance with embodiments of the invention. Systems and methods for content display devices in accordance with embodiments of the invention are discussed below.

### Content Display Devices

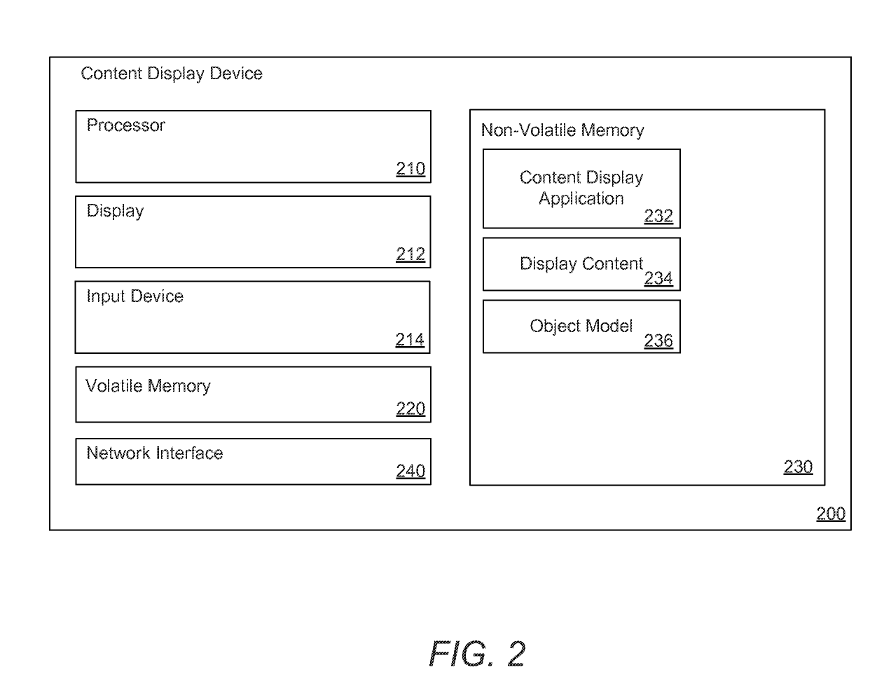

Content display devices in accordance with embodiments of the invention are configured to render content having discrete content zones and allow for interaction with the rendered content. A conceptual illustration of a content display device in accordance with an embodiment of the invention is shown in FIG. 2. The content display device 200 includes a processor 210 in communication with volatile memory 220 and non-volatile memory 230. The content display device 200 also includes a network interface 240 configured to send and receive data over a network connection. In a number of embodiments, the network interface 240 is in communication with the processor 210, the non-volatile memory 230, and the volatile memory 220.

The content device 200 includes a display 212 and an input device 214 connected to the processor 210. The processor 210 is configured by the content display application 232 to render display content 234 having discrete content zones for display using the display 212. The content display application 232 configures the processor 210 to assign additional content to one or more of the discrete content zones and render the content having discrete content zones. In several embodiments, the content display application 232 configures the processor 210 to generate an in-memory object model 236 representing the content and render the content for display via the display 212 using the in-memory object model 236. Additionally, the content display application 232 configures the processor 210 to dynamically resize one or more of the discrete content zones based on the additional content contained within each discrete content zone. The processor 210 is configured to receive input for displaying and navigating the rendered content using the input device 214. The content display application 232 configures the processor 210 to independently map the received input to at least one of the discrete content zones in the rendered content. In a variety of embodiment, the content display application 232 configures the processor 210 to interrupt the mapping of the received input to at least one of the discrete content zones. In many embodiments, the display 212 is a monitor, cell phone display, or other device capable of displaying content. In several embodiments, the input device 214 is one or more of a variety of devices, including, but not limited to, mice, keyboards, touch screens, and cameras configured to track movement.

In several embodiments, non-volatile memory is any form of non-volatile storage configured to store a variety of data, including, but not limited to, a content display application 232, display content 234, and an object model 236. In a variety of embodiments, the display content 234 and/or the object model 236 are stored using the volatile memory 220. The content display application 232 configures the processor 210 to retrieve the display content 234 and/or the object model 236 for rendering and display and to store generated in-memory data models of web pages for storage and later retrieval.

The network interface 240 is configured to receive display content 234 having discrete content zones and additional content from a variety of sources, including, but not limited to, web servers and content sources via a network and provide the received content to the processor 210, the non-volatile memory 230, and/or the volatile memory 220. The content display application 232 configures the processor 210 to generate requests for content having discrete content zones and/or additional content and transmit those requests using the network interface 240. In many embodiments, the content display application 232, the display content 234, and/or the object model 236 are stored using an external server system and received by the content display device 200 using the network interface 240.

Although a specific architecture for a content display device in accordance with an embodiment of the invention is conceptually illustrated in FIG. 2, any of a variety of architectures, including those which store data or applications on disk or some other form of storage and are loaded into volatile memory 220 at runtime, and or systems that are distributed across multiple physical servers, can also be utilized. Methods for displaying content with discrete content zones in accordance with embodiments of the invention are discussed below.

Receiving and Rendering Content with Discrete Content Zones

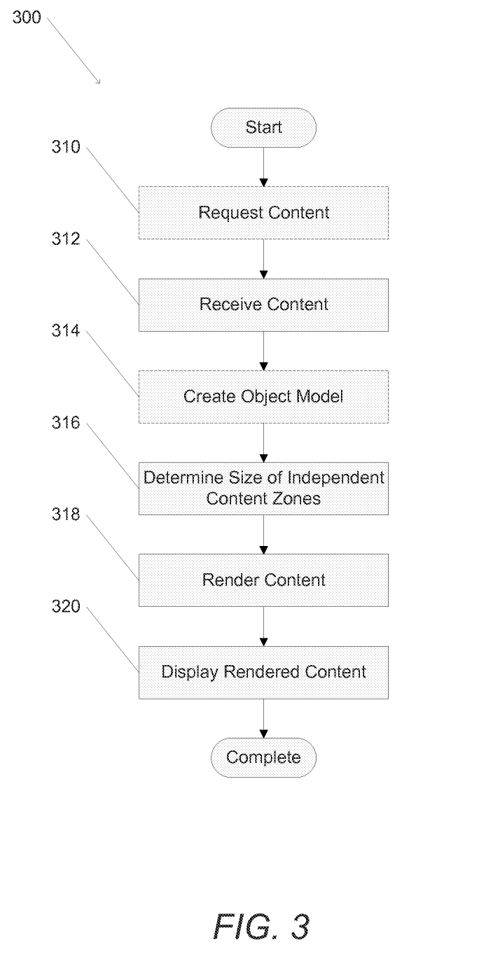

Content with discrete content zones provides a unique way of presenting content, allowing for a high degree of flexibility and configurability in the presentation of the content. Content with discrete content zones in accordance with a variety of embodiments of the invention provide a single model, such as a DOM, describing the content that enables the association of actions between discrete content zones. Content with discrete content zones also allows a degree of flexibility and configurability on content display devices that do not support communication between different models and those that do not support the display of multiple models at the same time. A process for receiving and rendering content with discrete content zones in accordance with an embodiment of the invention is illustrated in FIG. 3. In many embodiments, the process 300 includes requesting (310) content with discrete content zones. The process 300 further includes receiving (312) content with discrete content zones. In many embodiments, an in-memory object model is created (314) using the received content. The size of one or more of the discrete content zones contained in the received content is determined (316). The content is rendered (318) and displayed (320).

In many embodiments, requesting (310) and/or receiving (312) content with discrete content zones utilizes the hypertext transfer protocol (HTTP) and/or a secured version of HTTP, such as HTTP Secure. HTTP is defined in RFC 2616, published by the Internet Engineering Task Force, the entirety of which is incorporated by reference. In other embodiments, any of a variety of stateless and/or stateful data transfer protocols can be utilized. In several embodiments, the received (312) content with discrete content zones is a web page containing HTML, CSS, and one or more scripts; the web page indicates discrete content zones utilizing a <div> tag and/or a custom HTML tag. In a number of embodiments, receiving (312) content further includes receiving additional content linked to in the received web page. In many embodiments, the in-memory object model crated (314) is a DOM. In several embodiments, determining (316) the size of one or more discrete content zones utilizes additional content that is contained in the discrete content zones and one or more of the received scripts. In a number of embodiments, one or more of the discrete content zones has a minimum width and/or height. In many embodiments, one or more of the discrete content zones has a maximum width and/or height. In several embodiments, the determined (316) size of one or more of the discrete content zones is based upon the device displaying (320) the content. Determining (314) the size of one or more of the discrete content zones includes modifying the received (312) content and/or the created (314) in-memory object model. In a number of embodiments, rendering (318) the content utilizes the received (312) content and/or the created (314) in-memory object model.

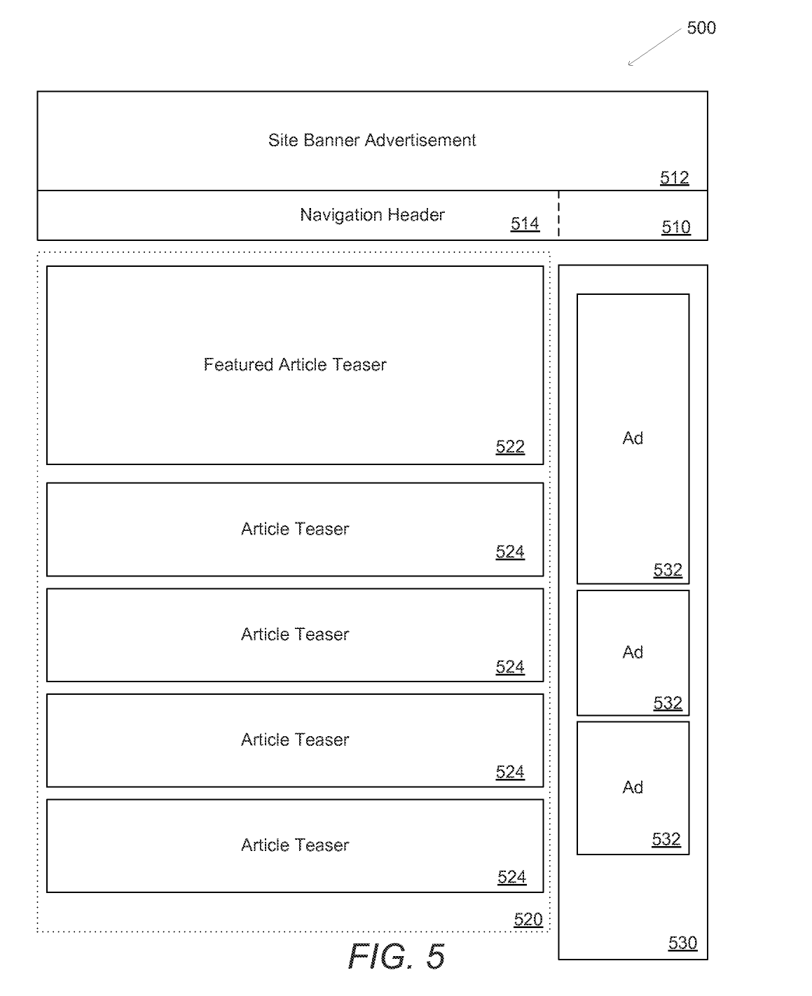

By way of example, a piece of content, in this case a web page, having a discrete content zone in accordance with an embodiment of the invention is conceptually illustrated in FIG. 5. The content with a discrete content zone 500 includes a header 510, a primary content zone 520, and a discrete content zone 530. The header 510 includes a site banner advertisement 512 and a navigation header 514. The layout and appearance of the header 510, the primary content zone 520, and the discrete content zone 530 is controlled using a CSS contained in the received (312) content. The primary content zone 520 contains a featured article teaser 522 and a plurality of article teasers 524. The discrete content zone 530 contains a plurality of advertisements 532. The featured article teaser 522, the article teasers 524, and the navigation header 514 were received (312) as part of a web page; the ads 532 and the site banner advertisement 512 were received (312) as additional content. The height of the discrete content zone 530 was determined (314) based upon the received (312) ads 532. The height of the discrete content zone can be expressed in the rendered (318) content by modifying the received (312) content and/or the created (314) DOM representing the received (312) content using a script contained in the received (312) content that is then displayed (320).

A specific example of content with a discrete content zone is described above with respect to FIG. 5; however, a variety of content with discrete content zones, including those that contain a plurality of discrete content zones, may be utilized in accordance with embodiments of the invention. Although a specific process for receiving and rendering content with discrete content zones where the content is a HTML web page is described above with respect to FIG. 3, any number of processes for rendering content with discrete content zones can be utilized in accordance with embodiments of the invention. Processes for interacting with content having discrete content zones in accordance with embodiments of the invention are discussed below.

Interacting with Content with Discrete Content Zones

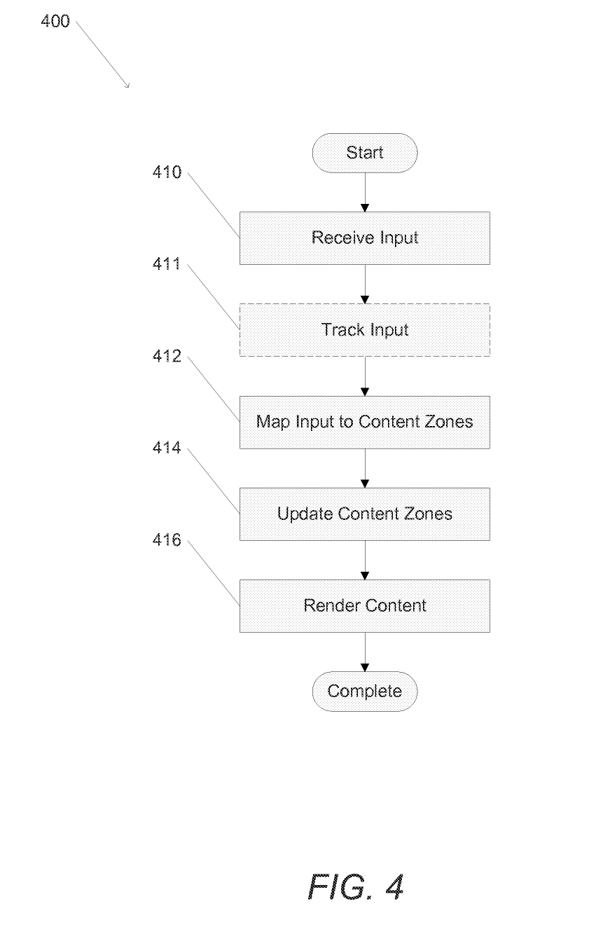

Once content is displayed, content display devices are configured to allow for interaction with the displayed content, allowing users to view the displayed content. A process for interacting with content having discrete content zones in accordance with embodiments of the invention is illustrated in FIG. 4. The process 400 includes receiving (410) input. In several embodiments, the received (410) input is tracked (411). The received (410) input is mapped to one or more discrete content zones. One or more content zones are updated (414) and the content is rendered (416).

In a number of embodiments, tracking (411) input includes logging the nature, distance, and/or the direction the received (410) input. In many embodiments, the received (410) input is an event representing vertical and/or horizontal motion with respect to a web page displayed using a content display device. In several embodiments, the input is mapped (412) to one or more discrete content zones using one or more scripts contained in the web page. In a number of embodiments, updating (414) a discrete content zone includes resizing the discrete content zone in response to the received (410) input. In a variety of embodiments, updating (414) a discrete content zone includes aligning the discrete content zone with another content zone in the web page. In many embodiments, updating (414) a discrete content zone includes determining which portion of the content contained in the discrete content zone is displayed. In several embodiments, updating (414) a discrete content zone includes modifying the modifying the mark up contained within the original source file downloaded by the web browser application corresponding to the discrete content zone and/or modifying an in-memory object corresponding to the discrete content zone using a script contained in the web page. In a number of embodiments, additional content is loaded into a discrete content zone based upon the input mapped (412) to the discrete content zone; updating (414) the discrete content zone includes rendering (416) the additional content. For example, the additional content can be utilized to implement a discrete content zone that will scroll infinitely based upon the mapped (412) input, or at least until no more additional content exists to be loaded into discrete content zone.

In several embodiments, the web page contains a header section and/or a footer section that bracket the discrete content zones; mapping (412) the input to the discrete content zones depends on if the header and/or footer section is included in the rendered (416) content. In many embodiments, one or more of the discrete content zones contains a header and/or footer that are utilized in the mapping (412) of the input and rendering (416) of the content. For example, a header may appear above a discrete content zone in a web page; the discrete content zone may not begin independently scrolling its contained content until after the header is not rendered (416). In another instance, the discrete content zone may appear next to the header and the discrete content zone will independently scroll while the header is rendered (416). In a number of embodiments, discrete content zones may attach themselves to a portion of the rendered (416) web page based upon the input mapped (412) to the discrete content zone. In a variety of embodiments, one or more discrete content zones can pause their scrolling based upon the input mapped (412) to the discrete content zone; likewise, the discrete content zone can resume scrolling after additional input is mapped (412) to the discrete content zone. A process such as the one described above with respect to FIG. 3 may be utilized to update (414) and/or render (416) the content.

In accordance with embodiments of the invention, updating (414) a discrete content zone includes computing how the discrete content zone will change based upon the received (410) input and redrawing the relevant portion of the discrete content zone as part of the of the update (414) step. This update (414) may be implemented in a variety of ways, such as by using bitmap caching and only rendering (416) the portion of the web page that is updated (414) in response to the received (410) input.

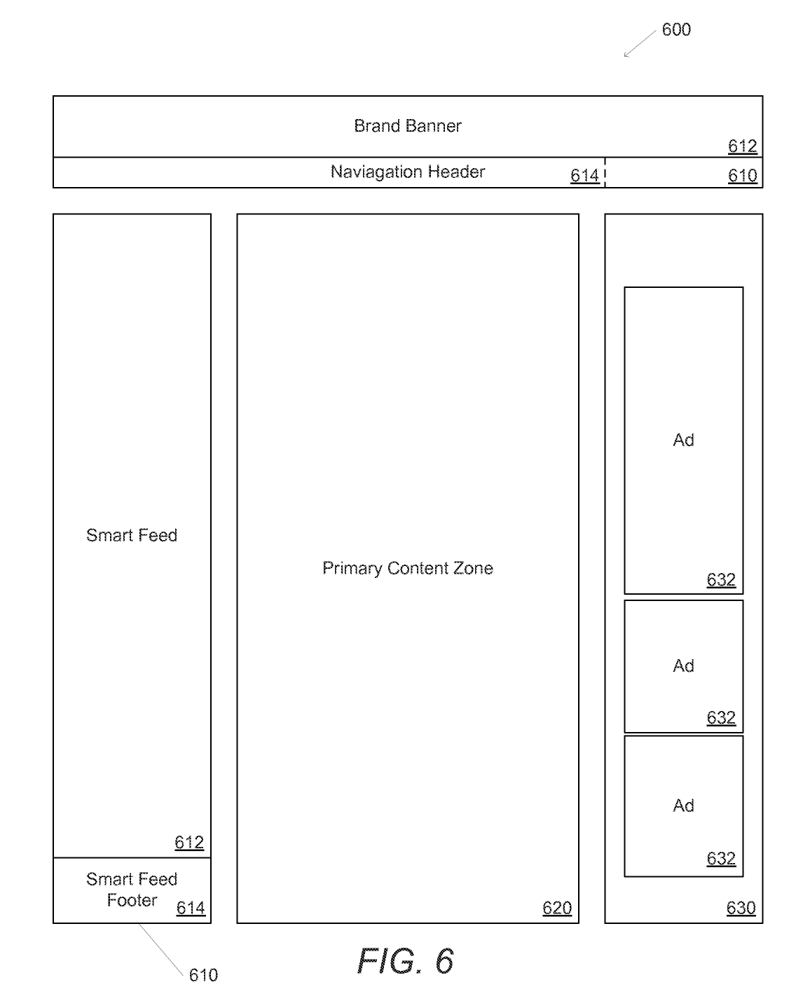

By way of example, interacting with content having discrete content zones is conceptually illustrated in FIG. 6. The web page 600 contains a header 610, a first discrete content zone 610, a primary content zone 620, and a second discrete content zone 630. The header contains a brand banner 612 and a navigation header 614. The first discrete content zone 610 contains a smart feed 612 and a smart feed footer 614. The second discrete content zone 630 contains a plurality of advertisements 632. Input indicative of a downward scroll is received (410) and the web page 600 is rendered (416) accordingly until the end of the navigation header 614 is reached. Once the end of the navigation header 614 is reached, the navigation header 614 attaches itself to the top of the rendered (416) web page. The elements in the web page corresponding to the first discrete content zone 610 and the second discrete content zone 630 have the same height that corresponds to the height of the display of the content display device; the primary content zone 620 has a greater height. As additional input is received (410), the discrete content zones are configured to map (412) the received input in order to scroll through the content contained in the discrete content zone at a rate double that of the primary content zone. In a variety of embodiments, the rate can be any multiple or fraction of the rate of the primary content zone. The final ad 632 in the second discrete content zone 630 is rendered (416) before the end of the primary content zone is rendered (416); the second discrete content zone is updated (414) to fix itself to the rendered (416) window and be static as the primary content zone 620 continues to update (414). The first discrete content zone 610 also initially contains content shorter than the height of the primary content zone 620. However, once the smart feed footer 614 is rendered (416), the first discrete content zone is updated (414) by loading additional content to be rendered (416). In this manner, the first discrete content zone 620 is configured to continue present content to be rendered (416) based upon the mapped (412) input until the end of the primary content zone 620 is reached and the content display device stops scrolling the web page based on the received (410) input. In a variety of embodiments, the height of the smart feed 612 is updated as additional content is loaded into the smart feed 612.

A specific example of content with two discrete content zone and interactions with that content is described above with respect to FIG. 6; however, a variety of content and interactions may be utilized in accordance with embodiments of the invention. Although a specific process for interacting with content with discrete content zones is described above with respect to FIG. 4, any number of processes for interacting with content having discrete content zones may be utilized in accordance with embodiments of the invention.

Although the present invention has been described in certain specific aspects, many additional modifications and variations would be apparent to those skilled in the art. It is therefore to be understood that the present invention may be practiced otherwise than specifically described without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. A content display device, comprising:
memory configured to store a content display application;
a network interface configured to receive web page data;
a display configured to display content data;
an input device configured to receive input data; and
a processor;
wherein the content display application configures the processor to:
receive web page data using the network interface, where the web page data includes a plurality of pieces of content data and at least one script;
generate an object model using the at least one piece of content data;
render the received web page data using the object model, where the rendered web page data contains a plurality of discrete content zones and at least one piece of content data is associated with each discrete content zone;
display the rendered web page data using the display;
receive input using the input device;
modify the generated object model using the received input and the at least one script, where the at least one script is configured to independently map the received input to one or more of the discrete content zones;
re-render the web page data using the modified object model; and
display the re-rendered web page data using the display.

2. The content display device of claim 1, wherein:
the web page data includes a link to remote content data; and
the content display application further configures the processor to receive remote content data using the link to remote content data.

3. The content display device of claim 1, wherein:
the web page data includes at least one cascading style sheet; and
the content display application further configures the processor to render the received web page data using the at least one cascading style sheet.

4. The content display device of claim 3, wherein the content display application further configures the processor to select a cascading style sheet from the at least one cascading style sheet based upon the display and the input device, where the selected cascading style sheet is used to render the received web page data.

5. The content display device of claim 1, wherein:
the received input includes scrolling data; and
rendering the received web page data includes determining the portion of the web page data is visible in at least one discrete content zone using the scrolling data.

6. The content display device of claim 5, wherein:
at least one piece of content data further comprises a smart footer; and
the content display application further configures the processor to:
request additional content when the smart footer is rendered;
associate the requested additional content with the discrete content zone associated with the piece of content data having the smart footer; and
update the object model using the requested additional content.

7. The content display device of claim 6, wherein:
the at least one discrete content zones comprises a discrete content zone height; and
the content display application further configures the processor to update the discrete content zone height when additional content is associated with the discrete content zone.

8. The content display of claim 1, wherein:
the received web page further comprises a web page header;
each discrete content zone in the plurality of discrete content zones further comprises a discrete content zone top; and
the content display application further configures the processor to:
render the web page such that the web page header appears at the beginning of the rendered web page; and
independently map input to the plurality of discrete content zones so that the top of each discrete content zone is aligned with the web page header.

9. The content display of claim 1, wherein:
the received web page further comprises a web page footer;
each discrete content zone in the plurality of discrete content zones further comprises a discrete content zone bottom; and
the content display application further configures the processor to:
render the web page such that the web page footer appears at the end of the rendered web page; and
independently map input to the plurality of discrete content zones so that the bottom of each discrete content zone is aligned with the web page footer.

10. The content display device of claim 1, wherein the content display application further configures the processor to:
determine when a first discrete content zone has displayed all of the pieces of content data associated with the first discrete content zone have been displayed;
determine that a second discrete content zone has additional pieces of content data associated with the second discrete content zone that have not been displayed;
fix the position of the second discrete content zone relative to the first discrete content zone; and
continue mapping input data to the second discrete content zone to cause the display of additional pieces of content data associated with the second discrete content zone that have not been displayed.

11. A method for displaying content with discrete content zones, comprising:
receiving web page data using a content display device, where the web page data includes a plurality of pieces of content data and at least one script;
generating an object model using the at least one piece of content data and the content display device;
rendering the received web page data using the object model and the content display device, where the rendered web page data contains a plurality of discrete content zones and at least one piece of content data is associated with each discrete content zone;
displaying the rendered web page data using the content display device;
receiving input using the content display device;
modifying the generated object model using the received input, the at least one script, and the content display device, where the at least one script is configured to independently map the received input to one or more of the discrete content zones;
re-rendering the web page data using the modified object model and the content display device; and
displaying the re-rendered web page data using the content display device.

12. The method of claim 11, further comprising receiving remote content data using the content display device, where the web page data includes a link to the remote content data.

13. The method of claim 11, further comprising rendering the received web page data using the content display device and at least one cascading style sheet included in the web page data.

14. The method of claim 13, further comprising selecting a cascading style sheet from the at least one cascading style sheet based upon the content display device using the content display device, where the selected cascading style sheet is used to render the received web page data.

15. The method of claim 11, further comprising determining the portion of the web page data is visible in at least one discrete content zone in the rendered web page data using the content display device.

16. The method of claim 15, further comprising:
requesting additional content when a smart footer contained in a piece of content data is rendered using the content display device;
associating the requested additional content with the discrete content zone associated with the piece of content data having the smart footer using the content display device; and
updating the object model using the requested additional content and the content display device.

17. The method of claim 16, further comprising updating a discrete content zone height associated with the discrete content zone when additional content is associated with the discrete content zone using the content display device.

18. The method of claim 11, further comprising:
rendering the web page using the content display device such that a web page header included in the web page data appears at the beginning of the rendered web page; and
independently mapping input to the plurality of discrete content zones using the content display device so that the top of each discrete content zone is aligned with the web page header.

19. The method of claim 11, wherein:
rendering the web page using the content display device such that the web page footer appears at the end of the rendered web page; and
independently mapping input to the plurality of discrete content zones using the content display device so that the bottom of each discrete content zone is aligned with the web page footer.

20. The method of claim 11, further comprising:
determining when a first discrete content zone has displayed all of the pieces of content data associated with the first discrete content zone have been displayed using the content display device;
determining that a second discrete content zone has additional pieces of content data associated with the second discrete content zone that have not been displayed using the content display device;
fixing the position of the second discrete content zone relative to the first discrete content zone using the content display device; and
continuing mapping input data to the second discrete content zone to cause the display of additional pieces of content data associated with the second discrete content zone that have not been displayed using the content display device.
